(19) United States
(12) Patent Application Publication
(10) Pub. No.: US 2025/0149200 A1
(43) Pub. Date: May 8, 2025

(54) CONTAINER FOR AN ELECTRODEPOSITED SOLID TARGET MATERIAL FOR THE PRODUCTION OF A RADIOISOTOPE

(71) Applicant: COMECER S.P.A., Castel Bolognese (IT)

(72) Inventors: Alessandro Brunetti, Castel Bolognese (IT); Marco Testa, Castel Bolognese (IT)

(21) Appl. No.: 18/835,927

(22) PCT Filed: Feb. 8, 2023
(86) PCT No.: PCT/IB2023/051112

§ 371 Date: Aug. 5, 2024

(30) Foreign Application Priority Data
Feb. 9, 2022 (IT) 102022000002333
Feb. 9, 2022 (IT) 102022000002336

(51) Int. Cl. G21G 1/10; G21K 5/08

(52) U.S. Cl. CPC G21G 1/10; G21K 5/08

(57) ABSTRACT

A container for a solid target material and a radioisotope produced by proton beam irradiation of the solid target material, the container having a support body, which extends according to a longitudinal axis of the container and has a cylindrical portion having a first longitudinal end defined by a planar face, transverse to the longitudinal axis and suitable to receive, by electrodeposition, a portion of solid target material, and a cup cap, which is fitted coaxially onto the support body to cover it and has a bottom traversable by the proton beam and transverse to the longitudinal axis to define, together with the face, an interspace to contain the portion of solid target material and the radioisotope subsequently produced.

### CROSS-REFERENCE TO RELATED APPLICATIONS

This patent application claims priority from Italian Patent Applications No. 102022000002333 filed on Feb. 9, 2022, and No. 102022000002336 filed on Feb. 9, 2022, the entire disclosure of which is incorporated herein by reference.

### TECHNICAL FIELD

The present invention relates to a container for containing a solid target material and a radioisotope produced by proton beam irradiation of the solid target material, and a corresponding irradiation station that uses this container.

In particular, the present invention finds advantageous, but not exclusive, application in the production of a radioisotope using a low- or medium-energy cyclotron, namely, a cyclotron with energy less than or equal to 18 MeV, starting from a solid precursor material, also known as a solid target material, electrodeposited on an appropriate metal support, to which the following description will make explicit reference without thereby losing generality.

### BACKGROUND

To date, various types of radioisotopes for pharmaceutical use (radiopharmaceuticals) are derived following irradiation by a proton beam (proton bombardment) of a solid target material typically of metal origin.

The process for producing a radioisotope from a solid target material basically involves the following steps: electrodeposition (“electroplating”) of the solid target material on a metal support; irradiation by proton beam of the solid target material on the support; dissolution of the irradiated solid target material to obtain a solution in which the radioisotope produced by proton irradiation is present; and purification of the aforesaid solution to separate the radioisotope from the target material that has not reacted and from impurities. The aforesaid steps are carried out at relative processing stations, and therefore the support comprising the solid target material must be arranged inside a container for transport between multiple processing stations, for example, from the electrodeposition station to the irradiation station and from the irradiation station to the dissolution station.

Systems for producing a radioisotope are known which comprise an electrodeposition station, an irradiation station, a dissolution station, a purification station, and an automatic transport system for transporting, between some of the aforesaid stations, the container that contains the support with the solid target material yet to be irradiated or already irradiated. For this reason, this container is also known as a “shuttle.”

The irradiation station comprises a cyclotron to emit the proton beam against the solid target material and a fluid cooling system that is connected to the support for relative cooling during proton bombardment. In addition, supports suitable for being placed directly in the dissolution station and capable of resisting the agents that produce the solution with the radioisotope are known.

The production efficiency of the radioisotope depends strongly on the extent of the layer of solid target material that is irradiated by the proton beam and therefore by the cross-sectional area of the proton beam. In fact, the thickness of the solid target material layer should not exceed an optimal value, beyond which the average energy yielded by the proton beam would not be absorbed by all of the solid target material and therefore there would be a decrease in the productivity of the radioisotope.

In addition, the containers known for radioisotope production are not hermetic and therefore cannot be used to contain some solid precursor materials, such as, for example, radioactive metals. For example, the metal 226-Ra is radioactive and spontaneously releases, by alpha decay, the gas 222-Rn, which is also radioactive.

Some known fluid cooling systems provide for circulating a cooling fluid in an internal axial cavity of the support of the solid target material. In particular, the support has a cylindrical shape and comprises a coaxial cavity, which communicates with the outside through a channel and is partly delimited by the wall of the support on which, on the outside, the solid target material is deposited. The fluid cooling system comprises a connector that, in use, is positioned in the channel to supply the fluid with a first flow in an axial direction and is configured to take up the fluid through a second flow external and concentric to the first flow such that the fluid laps the inner surface of said wall in a radial manner.

However, the fluid cooling system described above has been shown to be inefficient as it does not adequately cool all the perimeter portions of the solid target material deposited on the support.

### SUMMARY

The purpose of the present invention is to provide a container for electrodeposited solid target material and an irradiation station, which are free from the drawbacks described above and, at the same time, are easy and inexpensive to manufacture.

According to the present invention, a container for a solid target material and a radioisotope produced by proton beam irradiation of the solid target material, a method for producing a radioisotope, an irradiation station for a radioisotope production system, and a radioisotope production system are provided according to what is defined in the appended claims.

### BRIEF DESCRIPTION OF THE DRAWINGS

The present invention will now be described with reference to the appended drawings, which illustrate a non-limiting embodiment thereof, wherein:

FIG. 1 illustrates an exploded axonometric view of the container manufactured according to the present invention;

FIG. 2 illustrates the container of FIG. 1 according to a sectional view along a plane on which the longitudinal axis of the container 1 lies;

FIG. 3 illustrates the container of FIG. 1 according to a sectional view along another plane on which the longitudinal axis lies and orthogonal to the plane of section of FIG. 2;

FIG. 4 illustrates a component of the container of FIG. 1 according to an axonometric view in which some internal characteristics of the component are highlighted by dashed lines;

FIG. 5 illustrates the component of FIG. 4 during the irradiation step of a portion of solid target material present on a face of the component; and

FIG. 6 schematically illustrates an irradiation station of a radioisotope production system that uses the container of FIG. 1.

### DESCRIPTION OF EMBODIMENTS

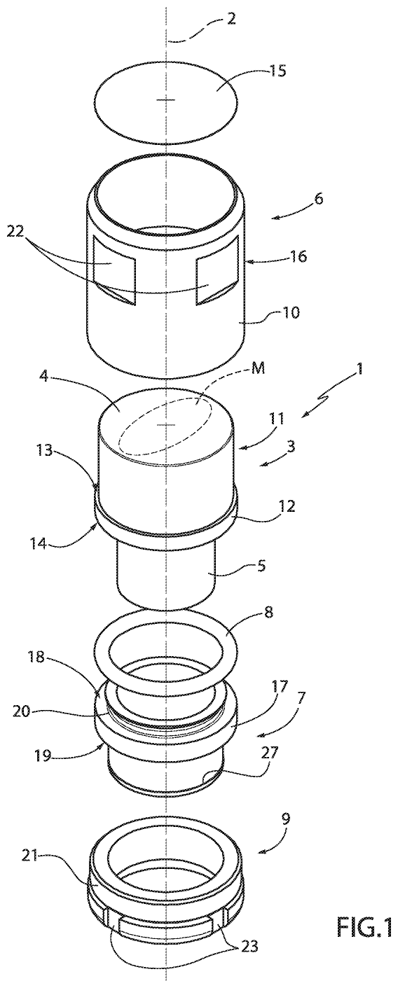

In FIG. 1, 1 generically denotes, as a whole, the container of the present invention suitable for containing a solid target material and a radioisotope produced by proton beam irradiation of the solid target material. The container 1 has a longitudinal axis 2 and comprises a support body 3 for the solid target material, which extends according to the longitudinal axis 2 and comprises a planar face 4, which is transverse, and in particular orthogonal, to the longitudinal axis 2, and on which is electrodeposited a portion of solid target material, illustrated with a dashed line and indicated by M in FIG. 1, and a cup cap 6, which is suitable to be coaxially fitted on, namely around, the support body 3, so as to coaxially cover the support body 3.

In addition, the support body 3 comprises a neck 5 extending from the axially opposite side of the face 4, and the container 1 comprises a spacer ring 7, which is fitted on the neck 5, in particular without interference, a hermetic sealing ring 8, which is fitted on the spacer ring 7, and a ferrule 9, which is fitted on the spacer ring 7 and couples with an end portion 10 of the cup cap 6 so as to pack close the container 1.

The support body 3 has a symmetrically cylindrical external shape with respect to the longitudinal axis 2. In particular, the support body 3 comprises a cylindrical portion 11 having a first longitudinal end that is defined by the face 4. In other words, the face 4 is defined by a circular end base of the cylindrical portion 11. The neck 5 extends from a second longitudinal end of the cylindrical portion 11, namely, from the axially opposite side of the face 4, coaxially to cylindrical portion 11 itself. The neck 5 has a smaller diameter than that of the cylindrical portion 11. From the axially opposite side of the face 4, the cylindrical portion 11 ends with a rib 12 projecting outwards which defines two shoulders 13 and 14 opposite each other.

The cup cap 6 is fitted on the support body 3 around the cylindrical portion 11 so as to cover the latter.

The support body 3 is made of aluminium. The cylindrical portion 11, excluding the rib 12, is coated with a thin layer of coating material, which is suitable for electrodeposition of the solid target material M and is inert to acidic substances that are used to dissolve the solid target material after it has been irradiated by the proton beam. In fact, aluminium is a light material that is easy to process to obtain components of the desired shapes, but it dissolves in the acids used during the dissolution step of the process to produce the radioisotope.

The coating material is made integral to the support body 3 by braze welding. Preferably, the coating material is platinum. The coating material has a thickness of less than 200 μm, and in particular of 100 μm.

The cup cap 6 comprises a bottom 15 that is traversable by a proton beam. In other words, the bottom 15 provides negligible attenuation to the proton beam.

In particular, the cup cap 6 comprises a metal cylindrical body 16, which has a first longitudinal end closed by the bottom 15 and a second longitudinal end open so as to be engaged by the support body 3. So, the bottom 15 has a circular shape. The bottom 15 is a metal foil, preferably having a thickness of less than 100 μm, and in particular of 50 μm. The end portion 10 is defined at the second longitudinal end of the cylindrical body 16. When the cup cap 6 is fitted on the support body 3, the cylindrical body 16 is fitted around the cylindrical portion 11 of the support body 3.

The cup cap 6 is made of aluminium. In particular, the cylindrical body 16 and the bottom 15 are made of aluminium. The bottom 15 is joined to the cylindrical body 16 by laser micro-welding along an annular edge of the cylindrical body 16.

The spacer ring 7 comprises an outwardly projecting rib 17 that defines two shoulders 18 and 19 opposite each other. The shoulder 18 faces the shoulder 14 of the cylindrical portion 11 of the support body 3. The spacer ring 7 also comprises a groove 20 arranged adjacent to the shoulder 18 and acts as a seat for the hermetic sealing ring 8. The hermetic sealing ring 8 is a common O-ring arranged between the shoulder 14 of the support body 3 and the shoulder 18 of the spacer ring 7.

The end portion 10 of the cup cap 6 is internally threaded, and the ferrule 9 has an outer threaded portion 21 to screw onto the end portion 10.

The spacer ring 7 and the ferrule 9 are both made of aluminium.

The cup cap 6 comprises a plurality of external notches 22 and similarly the ferrule 9 comprises a plurality of external notches 23 to facilitate the grip of an operator's finger during the pack closing of the container 1 and/or to allow a releasable mechanical coupling with support means of a radioisotope production system, not illustrated in FIGS. 1 to 4.

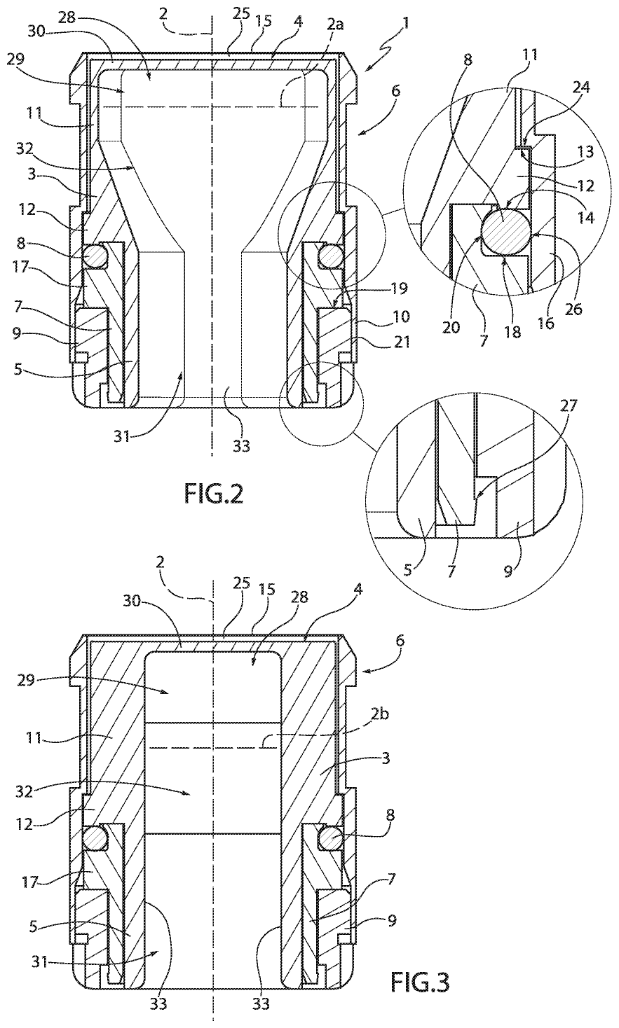

With reference to FIGS. 2 and 3, which illustrate the container 1 according to two respective cross-sectional views along two planes orthogonal to each other at the longitudinal axis 2, the face 4 and the bottom 15 are transverse to the longitudinal axis 2, and in particular are parallel to each other. The bottom 15 covers the entire face 4.

The shoulder 13 of the support body 3 rests on an inner shoulder 24 of the cup cap 6, and in particular of the cylindrical body 16, so as to define between the face 4 and the bottom 15, an interspace 25 suitable for containing the portion of solid target material M (not illustrated in FIGS. 2 and 3) electrodeposited on the face 4 and the radioisotope produced after irradiation with a proton beam of the portion of solid target material.

The interspace 25 is very thin, namely, it has a much smaller thickness than the diameter of the face 4. In particular, the ratio of the thickness of the interspace 25 to the diameter of the face 4 is between 0.03 and 0.05. The thickness of the interspace 25 is substantially uniform.

The shoulders 13 and 24 are better illustrated in an enlarged detail of FIG. 2.

The outer threaded portion 21 of the ferrule 9 is screwable onto the end portion 10 of the cup cap 6 until the ferrule hits the shoulder 19, as illustrated in FIGS. 2 and 3. Due to the interference-free coupling between the neck 5 and the spacer ring 7, screwing the ferrule 9 onto the end portion 10 pushes the spacer ring 7 along the longitudinal axis 2 until it hits onto the shoulder 14 of the support body 3. This achieves the pack closing of the container 1.

The pack closing of the container 1 causes the hermetic sealing ring 8 to contact not only the shoulder 18 of the spacer ring 7, but also the shoulder 14 of the support body 3 and a lateral inner surface 26 of the cup cap 6, and in particular of the cylindrical body 16. In this way, an overall interspace, which comprises the interspace 25, between the support body 3 and the cup cap 6, and in particular between the cylindrical portion 11 of the support body 3 and an inner portion of the cup cap 6 extending from the bottom 15 to the shoulder 24, is hermetically closed. At the same time, the support body 3 can rotate with respect to the cup cap 6 around the longitudinal axis 2 so that the portion of solid target material M present on the face 4 can be oriented with respect to a proton beam that is projected from the outside onto the bottom 15 of the cup cap 6.

The spacer ring 7 comprises an annular tooth 27 projecting from its outer surface to axially hold the ferrule 9 on the spacer ring 7 once the ferrule 9 is fitted on the spacer ring 7. The annular tooth 27 is visible in FIGS. 1, 2 and 3 and is best illustrated in an enlarged detail of FIG. 2. Therefore, the ferrule 9, when fitted on the spacer ring 7 during the assembly of the container 1, undergoes some interference to overcome the annular tooth 27.

The support body 3 internally comprises a cavity 28, which comprises a first volume 29 located in the cylindrical portion 11 and extending diametrically below the face 4, and in particular parallel to the face 4, as can be seen from FIG. 2. In other words, the support body 3 comprises a flat wall 30 transverse, and in particular orthogonal, to the longitudinal axis 2, and this flat wall 30 has the face 4 outside the support body 3 and partially delimits the volume 29 inside the support body 3. In particular, the volume 29 extends predominantly along a direction 2a (FIG. 2) perpendicular to the longitudinal axis 2 (and therefore parallel to the face 4), namely, the volume 29 has a greater dimension along the direction 2a.

The cavity 28 comprises a second volume 31, which extends inside the neck 5 for its entire length to define an access conduit for a cooling fluid that communicates with the first volume 29 for the purpose of cooling the support body 3 during irradiation of the solid target material. Hereinafter, the characteristic indicated by the number 31 will be called second volume or access conduit depending on the particular context.

The cavity 28 comprises a third volume 32, which puts the first volume 29 in communication with the second volume 31 and is tapered from the first volume 29 to the second volume 31 except with respect to a given direction 2b (FIG. 3) orthogonal to the longitudinal axis 2. Preferably, the direction 2b is orthogonal to the direction 2a.

The overall volume of the cavity 28 is defined, with respect to the direction 2b, between two internal plane surfaces 33 of the support body 3, which are parallel to each other and to the longitudinal axis 2 and extend from the first volume 29 to the second volume 31.

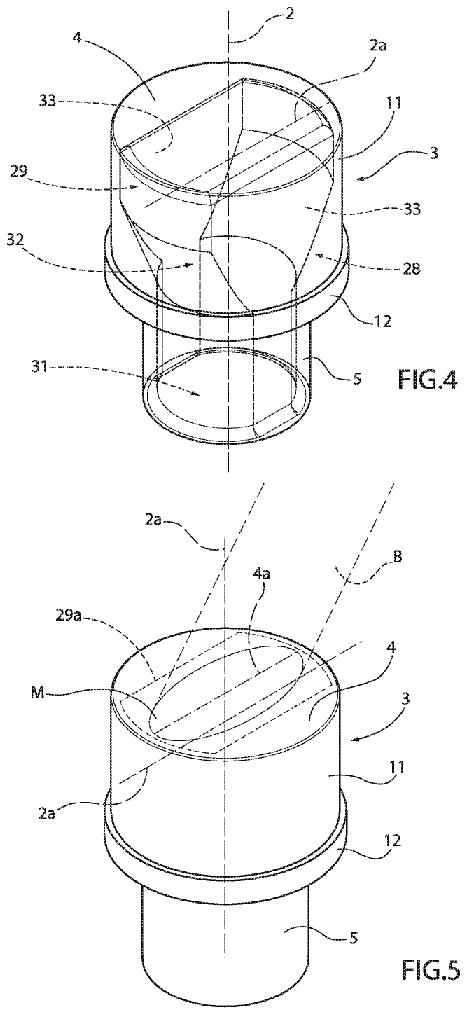

FIG. 4 illustrates an axonometric view of only the support body 3 in which the cavity 28 is drawn with dashed line to better show all its parts, such as volumes 29, 31 and 32 and internal plane surfaces 33. FIG. 4 also shows the numbers indicating the parts of the support body 3 described above.

The production of the radioisotope follows a method that comprises the steps of electrodepositing on the face 4 a portion of solid target material M and then irradiating the portion of solid target material M with a proton beam. The irradiation of the portion of solid material M occurs with the container 1 closed, then the proton beam reaches the face 4 after having passed through the bottom 15.

FIG. 5 illustrates the support body 3 of FIG. 4 after electrodeposition of the portion of target material M, and in particular during irradiation with the proton beam B. The proton beam B is directed obliquely onto the face 4 such that the beam section along the face 4 has an elliptical shape. In fact, the proton beam B typically has an orthogonal section of circular shape. In addition, the portion of target material M is electrodeposited so as to give it an elliptical shape substantially the same as that of the beam section, and the support body 3 is oriented so that the beam section overlaps exactly with the portion of solid target material M.

The portion of solid target material M is electrodeposited on the face 4 so that it remains within an area 29a of the face 4 defined by a projection of the volume 29 on the plane of the face 4 according to the longitudinal axis 2. This allows to maximizes the cooling of the portion of solid target material M during the irradiation step.

Preferably, the portion of solid target material M is electrodeposited so that its elliptical shape is centered on the longitudinal axis 2 and has a major axis 4a parallel to the direction 2a, as shown in FIG. 5. In other words, the major axis of the elliptical shape of the portion of solid target material M is arranged parallel to the internal plane surfaces 33 (FIG. 4). The internal plane surfaces 33 are visible from the access conduit 31 of the neck 5 of the support body 3. In this way, it is possible to identify the axial position of the portion of solid target material M and therefore correctly orientate the support body 3 with respect to the proton beam B even with the container 1 closed.

The elliptical shape of the portion of solid target material M allows the amount of solid target subjected to irradiation to be increased, with the same thickness of the portion of solid target material M, and therefore to increase the amount of radioisotope produced with the same energy of the cyclotron that generates the orthogonal cross section proton beam B. In fact, the thickness of the portion of solid target material M must remain within a certain range of values, otherwise proton bombardment would produce more impurities in addition to the desired radioisotope.

The oblique irradiation of the entire portion of solid target material M through the cup cap 6 is made possible by the fact that the cup cap 6 and the support body 3 substantially pose no obstacles to the oblique proton beam B due to the face 4 extending through the entire first longitudinal end of the cylindrical portion 11 and, similarly, the bottom 15 extending through the entire first longitudinal end of the cylindrical body 16.

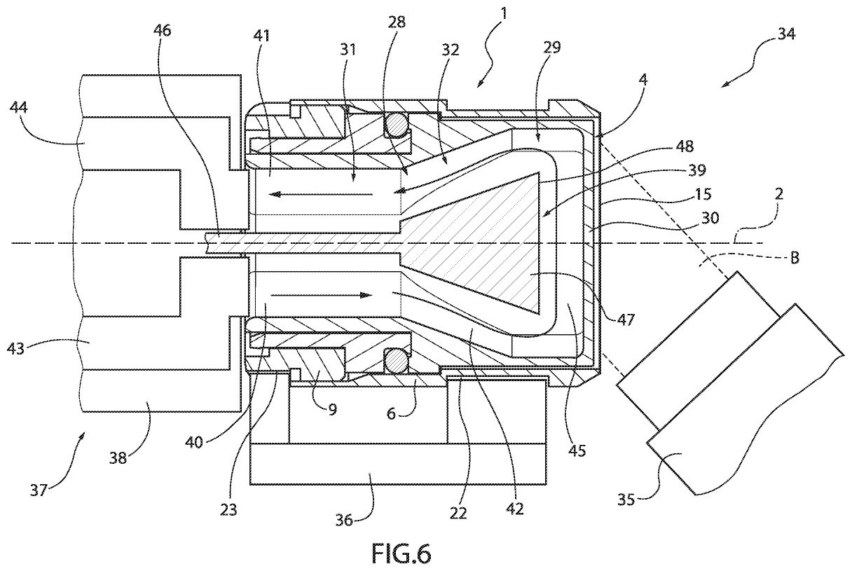

FIG. 6 illustrates in a schematic and simplified manner an irradiation station 34 of a radioisotope production system that comprises the container 1. The radioisotope production system is generally known per se, and therefore not illustrated in detail. The container 1 is used in the radioisotope production system to transfer the portion of solid target material M between several stations of the system, including precisely the irradiation station 34.

The irradiation station 34 comprises a cyclotron 35 of a known type for emitting the proton beam B against the portion of solid target material M arranged in the container 1. In particular, the irradiation station 34 comprises support means 36 of a known type for holding the container 1 in place with the bottom 15 of the cup cap 6 facing the cyclotron 35 so that the face 4, on which the portion of solid target material M (not illustrated in FIG. 6) is present, receives the proton beam obliquely, forming a predetermined angle with the longitudinal axis 2 so that the beam section along the face 4 has an elliptical shape equal to overlapping the elliptical shape of the portion of solid material M. For this purpose, the support means 36 couple, for example, to the notches 22 and 23 on the cup cap 6 and the ferrule 9.

The irradiation station 34 comprises a fluid cooling system 37 connected to the container 1 to cool the latter during irradiation of the solid target material M. In particular, the fluid cooling system 37 comprises a connection assembly 38 connectable to the base of the neck 5 of the support body 3 of the container 1 to introduce a cooling fluid into the cavity 28.

The container 1 is illustrated in FIG. 5 according to the same sectional view as in FIG. 2. The connection assembly 38 comprises a fluid diverter 39, which is suitable to enter the cavity 28 through the access conduit 31 in the direction of the longitudinal axis 2, and is shaped so as to divide the access conduit 31 into an inlet 40 and an outlet 41 for the cooling fluid and define, in the cavity 28, a circulation channel 42 for the cooling fluid extending between the inlet 40 and the outlet 41 substantially in a U-shape. The connection assembly 38 also comprises a delivery conduit 43 that communicates with the inlet 40 and a return conduit 44 that communicates with the outlet 41.

The circulation channel 42 comprises an intermediate section 45, which is located at the volume 29 and is parallel to the direction 2a (FIGS. 2 and 4), and in particular extends below the flat wall 30, so that the cooling fluid flows through the intermediate section 45 according to a laminar flow parallel to the direction 2a, directed from the inlet 40 to the outlet 41.

In more detail, the fluid diverter 39 comprises a first portion 46, which is suitable to be arranged in the access conduit 31 so as to divide it into the inlet 40 and outlet 41, and a second portion 47, which is tapered toward the first portion 46 according to a shape similar to that of the third volume 32 and is suitable to be arranged in at least the third volume 32, and in particular the majority of it in the third volume 32 and the remainder in the first volume 29.

The second portion 47 ends with a flat surface 48 which is suitable to be arranged parallel to the flat wall 30, namely, the face 4. This allows the intermediate section 45 of the circulation channel 42 to be defined. The flat surface 48 is the most transversely extended part of the second portion 47 and has a shape that falls within that of the cross section of the access conduit 31, and in particular that substantially coincides with this cross section, to allow the fluid diverter 39 to enter the cavity 28 without interference.

The fluid diverter 39 comprises two outer flat surfaces parallel to each other (not illustrated), each of which is suitable to slide along a respective internal plane surface 33 of the support body 3 when the fluid diverter 39 enters the cavity 28 or exits it through the access conduit 31. These two outer flat surfaces are parallel to the direction 2a (and therefore to the plane of section of FIG. 5) and for that reason cannot be illustrated in FIG. 5.

The outer flat surfaces of the fluid diverter 39 that run along the relative internal plane surfaces of the support body 3 allow the cavity 28 to be separated to obtain the circulation channel 42 and, at the same time, allow the fluid diverter device 39 to be inserted and extracted.

Although the invention described above makes particular reference to a very specific embodiment, it is not to be considered limited to this embodiment, all those variations, modifications or simplifications covered by the appended claims fall within its scope, such as:
the spacer ring 7 is fitted on the neck 5 with interference and the end portion 10 of the cup cap 6 couples directly to the spacer ring 7, and in particular to the rib 17, so that the ferrule 9 is not required for the pack closing of the container 1;
the container 1 is without the spacer ring 7, the neck 5 has a circular seat for the hermetic sealing ring 8, this circular seat being defined between the shoulder 14 and a rib that is radially projecting from the neck 5, and the end portion 10 of the cup cap 6 couples directly to the neck 5, for example, on this rib; and
support means 36 configured to hold the container 1 in place with the bottom 15 of the cup cap 6 facing the cyclotron 35 so that the face 4 receives the proton beam axially.

In addition, from what has been described above, it can be seen that the container 1 is also usable when the portion of solid target material M has a circular shape and the proton beam B is directed perpendicularly against the face 4, and in particular is centered on the longitudinal axis 2.

One of the advantages of the container 1 described above is the increase in the production efficiency of the radioisotope using the same energy of the cyclotron 35 that generates the orthogonal cross section proton beam B, because the particular construction of the support body 3 and the cup cap 6 minimizes the obstacles between the face 4 and a proton beam B impacting the face 4 obliquely to irradiate a larger portion of solid target material M, and in particular having an elliptical shape equal to that of the section of the proton beam B along the face 4.

Another advantage of the container 1 is that it contains the solid target material in an interspace 25 that is hermetically sealed due to the particular arrangement of the hermetic sealing ring 8, but at the same time is penetrable by the proton beam through the bottom 15. This prevents radiation generated by the solid target material or radioactive gases and/or particles produced by the solid target material after proton irradiation from escaping the container 1 before or during radioisotope production. In particular, the ferrule 9 presses the hermetic sealing ring 8 into contact with the shoulders 14 and 18 and with the lateral inner surface 26 of the cup cap 6.

Another advantage is better cooling of the support body 3 and therefore of the portion of solid target material M during the irradiation step of the latter, due to the particular shape of the cavity 28, and in particular the first volume 29, which extends below the face 4 predominantly along the direction 2a, and which couples to the particular shape of the fluid diverter 39 of the fluid cooling system 37 to define a U-shaped circulation channel 42 having an intermediate section 45 parallel to the direction 2a that forces the cooling fluid to lap the flat wall 30 according to a laminar flow.

Cooling of the portion of solid material M is maximized when its perimeter remains within the area 29a.

Another advantage of the container 1 is the possibility of orienting the support body 3 with respect to the cup cap 6, due to the spacer ring 7 fitted without interference on the support body 3. This allows the portion of solid target material M in the container 1 to be correctly oriented around the longitudinal axis 2 before tightening the ferrule 9 to pack close the container 1, and therefore allows the container 1 to be correctly positioned in the irradiation station 34 so that the elliptical shapes of the portion of solid target material M deposited on the face 4 and of the beam section of the proton beam B along the plane of the face 4 overlap each other.

The aforesaid advantages are not at the expense of the practicality of use of the container 1 during the dissolution step of the radioisotope production process, due to the coating material present on the cylindrical portion 11 of the support body 3, which prevents the disintegration of the aluminium of which the support body 3 is made when the cylindrical portion 11 is immersed in the acid used for the dissolution of the irradiated solid target material that also comprises the radioisotope produced.

1. A container for a solid target material and a radioisotope produced by proton beam irradiation of the solid target material, the container (1) comprising: a support body (3), extending along a longitudinal axis (2) of the container (1) and comprising a cylindrical portion (11) having a first longitudinal end defined by a planar face (4), transverse to the longitudinal axis (2) and suitable for receiving, by electrodeposition, a portion of solid target material (M); and a cup cap (6), which is suitable to be coaxially fitted on the support body (3), and in particular around the cylindrical portion (11), to cover the support body (3) and comprises a bottom (15) traversable by the proton beam and transverse to the longitudinal axis (2) to define, together with the face (4), an interspace (25) to contain the portion of solid target material (M) and the radioisotope subsequently produced.

2. The container according to claim 1, wherein said bottom (15) is a metal foil, preferably having a thickness of less than 100 μm.

3. The container according to claim 1, wherein the support body (3) comprises a neck (5) extending from a second longitudinal end of the cylindrical portion (11) coaxially to the latter and said cylindrical portion (11) comprises, at said second longitudinal end, a first shoulder (14); the container (1) comprising a hermetic sealing ring (8), which contacts said first shoulder (14) and a lateral inner surface (26) of the cup cap (6).

4. The container according to claim 3, and comprising a spacer ring (7), which is fitted on the neck (5) until hitting on the first shoulder (14) and has a second shoulder (18) facing the first shoulder (14); said hermetic sealing ring (8) being fitted on the spacer ring (7) to contact said first shoulder (14), said second shoulder (18) and the lateral inner surface (26) of the cup cap (6).

5. The container according to claim 4, wherein said spacer ring (7) is fitted on the neck (5) without interference.

6. The container according to claim 4, and comprising a ferrule (9), which is fitted on the spacer ring (7) and couples with an end portion (10) of the cup cap (6) so as to close the container (1).

7. The container according to claim 6, wherein said spacer ring (7) comprises an outer rib defining said second shoulder (18) and a third shoulder (19) opposite to said second shoulder (18), said end portion (10) is internally threaded and said ferrule (9) has an outer threaded portion (21) for screwing onto said end portion (10) of the cup cap (6) until it hits onto said third shoulder (19).

8. The container according to claim 6, wherein said cup cap (6) comprises a metal cylindrical body (16), which has a first longitudinal end closed by said bottom (15) and a second longitudinal end open so as to be engaged by the support body (3), said end portion (10) of the cup cap (6) being defined at the second longitudinal end of the cylindrical body (16).

9. The container according to claim 6, wherein said spacer ring (7) comprises an annular tooth (27) projecting from its outer surface for axially retaining the ferrule (9) on the spacer ring (7) once the ferrule (9) is fitted on the spacer ring (7).

10. The container according to claim 1, wherein said support body (3) is made of aluminium and at least said face (4) is coated with a coating material which is suitable for electrodeposition of the portion of solid target material (M) and which is inert to acidic substances capable of dissolving the portion of solid target material (M); preferably the coating material is platinum.

11. The container according to claim 1, wherein said support body (3) comprises a neck (5), which extends from a second longitudinal end of the cylindrical portion (11) coaxially to the latter, and an inner cavity (28), which comprises a first volume (29) extending below said face (4) predominantly along a first direction (2a) transverse to the longitudinal axis (2), and a second volume (31) communicating with the first volume (29) and extending into the neck (5) to define an access conduit for a cooling fluid.

12. The container according to claim 11, wherein said cavity (28) comprises a third volume (32), which puts the first volume (29) in communication with the second volume (31) and is tapered from the first volume (29) to the second volume (31) except with respect to a second direction (2b) orthogonal to the longitudinal axis (2) and preferably orthogonal to the first direction (2a); the overall volume of the cavity (28) being defined, with respect to the second direction (2b), between two internal plane surfaces (33) of the support body (3), which are parallel to each other and to the longitudinal axis (2) and extend from the first volume (29) to the second volume (31).

13. The container according to claim 1, wherein said cup cap (6) comprises a metal cylindrical body (16), which has a first longitudinal end closed by said bottom (15) and a second longitudinal end open so as to be engaged by the support body (3), the bottom (15) being joined to the cylindrical body (16) by laser micro-welding along an annular edge of the cylindrical body (16).

14. A container for a solid target material and a radioisotope produced by proton beam irradiation of the solid target material, the container (1) comprising a support body (3) extending along a longitudinal axis (2) of the container (1) and comprising: a cylindrical portion (11), which has a first longitudinal end defined by a planar face (4), transverse to the longitudinal axis (2) and suitable to receive, by electrodeposition, a portion of solid target material (M); a neck (5), which extends from a second longitudinal end of the cylindrical portion (11) coaxially to the latter; and an internal cavity (28), which comprises a first volume (29) extending below the face (4) predominantly along a first direction (2a) transverse to the longitudinal axis (2), and a second volume (31) communicating with the first volume (29) and extending into the neck (5) to define an access conduit for a cooling fluid.

15. The container according to claim 14, wherein said cavity (28) comprises a third volume (32), which puts the first volume (29) in communication with the second volume (31) and is tapered from the first volume (29) to the second volume (31) except with respect to a second direction (2b) orthogonal to the longitudinal axis (2) and preferably orthogonal to the first direction (2a); the overall volume of the cavity (28) being defined, with respect to the second direction (2b), between two internal plane surfaces (33) of the support body (3), which are parallel to each other and to the longitudinal axis (2) and extend from the first volume (29) to the second volume (31).

16. The container according to claim 14, wherein said support body (3) comprises a flat wall (30), which is transverse to the longitudinal axis (2), presents said face (4) outside the support body (3) and partially delimits said first volume (29) inside the support body (3).

17. An irradiation station for a radioisotope production system, the irradiation station (34) comprising a cyclotron (35) for emitting a proton beam (B) against a portion of solid target material (M) contained in a container (1) according to claim 11, and a fluid cooling system (37) for cooling the container (1) during irradiation of the portion of solid target material (M); the fluid cooling system (37) comprising a fluid diverter (39), which is designed to enter said cavity (28) through said access conduit (31) and is shaped to divide said access conduit (31) into an inlet (40) and an outlet (41) for the cooling fluid and define in said cavity (28) a circulation channel (42) for the cooling fluid; the circulation channel (42) extending between the inlet (40) and the outlet (41) and comprising, at said first volume (29), an intermediate section (45) parallel to the first direction (2a) in such a way that, in use, the cooling fluid assumes a laminar flow along the intermediate section (45).

18. The irradiation station according to claim 17, wherein said support body (3) of said container (1) comprises a flat wall (30), which is transverse to the longitudinal axis (2), presents said face (4) outside the support body (3) and partially delimits said first volume (29) inside the support body (3), and said fluid diverter (39) comprises a first portion (46), which is designed to be arranged in said access conduit (31) so as to divide it into said inlet (40) and outlet (41), and a second portion (47), which ends with a flat surface (48) designed to be arranged parallel to said flat wall (30) to define said intermediate section (45).

19. The irradiation station according to claim 18, wherein said fluid diverter (39) comprises two outer flat surfaces parallel to each other, each of which is designed to slide along a respective internal plane surface (33) of the support body (3) of the container (1) when the fluid diverter (39) enters the cavity (28) through the access conduit (31).

20. A radioisotope production system comprising a container (1) for containing a portion of solid target material (M) and an irradiation station (34) for emitting a proton beam (B) against the portion of solid target material (M) so as to obtain a radioisotope; the container (1) being according to claim 11 and the irradiation station (34) comprising a cyclotron (35) for emitting a proton beam (B) against a portion of solid target material (M) contained in the container (1), and a fluid cooling system (37) for cooling the container (1) during irradiation of the portion of solid target material (M); the fluid cooling system (37) comprising a fluid diverter (39), which is designed to enter said cavity (28) through said access conduit (31) and is shaped to divide said access conduit (31) into an inlet (40) and an outlet (41) for the cooling fluid and define in said cavity (28) a circulation channel (42) for the cooling fluid; the circulation channel (42) extending between the inlet (40) and the outlet (41) and comprising, at said first volume (29), an intermediate section (45) parallel to the first direction (2a) in such a way that, in use, the cooling fluid assumes a laminar flow along the intermediate section (45).

21. A method for producing a radioisotope comprising:
electrodepositing a portion of solid target material (M) on a flat face (4) of a support body (3) of a container (1) for solid target material, preferably the container (1) according to claim 1; and
irradiating the portion of solid target material (M) with a proton beam (B), preferably through the bottom (15) of the container (1) according to claim 1, to obtain the radioisotope;
the proton beam (B) being directed obliquely onto the flat face (4) such that a beam section along the flat face (4) has an elliptical shape, the portion of solid target material (M) having a shape substantially equal to said elliptical shape, and the support body (3) being oriented such that said beam section overlaps with the portion of solid target material (M).

22. The method according to claim 21, and further comprising:
while the portion of solid target material (M) is irradiated with the proton beam (B), cooling the support body (3) by circulation of a cooling fluid in an internal cavity (28) of the support body (3);
the internal cavity (28) comprising a first volume (29), which extends below the flat face (4) predominantly along a first direction (2a) parallel to the flat face (4), the portion of solid target material (M) being electrodeposited within an area (29a) of the flat face (4) defined by a projection of the first volume (29) onto the flat face (4) according to a direction (2) orthogonal to the flat face (4), and the cooling fluid being circulated in the first volume (29) according to a laminar flow parallel to the first direction (2a).

23. The irradiation station according to claim 17, wherein said fluid diverter (39) comprises two outer flat surfaces parallel to each other, each of which is designed to slide along a respective internal plane surface (33) of the support body (3) of the container (1) when the fluid diverter (39) enters the cavity (28) through the access conduit (31).
